(19) United States
(12) Patent Application Publication
(10) Pub. No.: US 2007/0182538 A1
(43) Pub. Date: Aug. 9, 2007

(54) Intruder detecting apparatus, intruder threatening apparatus, and intruder threatening apparatus for vehicle

(75) Inventors: Shunji Ota, Kyoto (JP); Akihiko Nakamura, Kyoto (JP); Masazumi Kubota, Kyoto (JP); Hisashi Takeuchi, Kyoto (JP); Shinichi Mukaigawa, Kyoto (JP); Hideyuki Kobayashi, Kyoto (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 10/591,053

(22) PCT Filed: Mar. 10, 2005
(86) PCT No.: PCT/JP05/04211

§ 371 Date: Aug. 30, 2006

(30) Foreign Application Priority Data
Mar. 15, 2004 (JP) 2004-073335

(51) Int. Cl. G08B 29/00; G08B 13/00

(52) U.S. Cl. 340/506; 340/541

(57) ABSTRACT

When a Doppler sensor (2) itself receives a change in a reflected wave generated by reflection of a microwave, which is transmitted by the Doppler sensor (2), to a detected object and detects movement of the object, an authentication processing unit (3) performs ID authentication processing. A control unit (4) gives an execution instruction for threatening processing to a threatening executing unit (10) on the basis of an output of authentication processing means.

### TECHNICAL FIELD

The present invention relates to an intruder detecting apparatus that detects approach of an object to a vehicle, a building, or the like, applies user authentication processing to the approach of the object, and causes external threatening processing executing means to execute threatening processing against an intruder according to results of the detection and the user authentication processing and relates to an intruder threatening apparatus including the intruder detecting apparatus.

### BACKGROUND ART

In recent years, there is a rapidly increasing need for a crime prevention apparatus for a vehicle and a building. As an example of a crime prevention apparatus widely on the market, there is a vehicle-mounted crime prevention apparatus that has a function for detecting vehicle abnormality such as a door opened illegally tilt of a vehicle and threatens an intruder into the vehicle with a siren when abnormality occurs.

In such a crime prevention apparatus, as a method with which a user performs setting or cancellation for a warning state of an intruder detecting apparatus, execution of threatening processing, or the like, there are an automatic system and a manual system.

In the manual system, the user intentionally performs operation and performs setting or cancellation for the warning state of the intruder detecting apparatus every time the user approaches or moves away from a crime prevention object.

On the other hand, in the crime preventing apparatus adopting intruder detection and threatening of the automatic system, even if the user does not intentionally perform operation, when the user approaches a crime prevention object, cancellation of the warning state of the intruder detecting apparatus is automatically performed and, when the user moves away from the crime prevention object, operation for shift to the warning state of the intruder detecting apparatus is automatically performed.

For example, when a user having a portable device capable of communicating with the intruder detecting apparatus approaches a crime prevention object such as a vehicle, ID authentication by communication between the portable device and the intruder detecting apparatus is performed and cancellation of the warning state of the intruder detecting apparatus is performed even if the user does not perform intentional operation such as pressing of a key switch of the portable device.

In the automatic system, a method of automatically setting the warning state of the intruder detecting apparatus when a set time has elapsed after a user turns off an engine in leaving a vehicle is also used.

In the conventional intruder detecting apparatus of the automatic system, ID information capable of specifying a user for performing ID authentication is usually registered in a portable device (a key, a remote controller, etc.) carried by the user and the intruder detecting apparatus. The ID information registered in the intruder detecting apparatus and the ID information registered in the portable device carried by the user are collated by authentication processing means to perform ID authentication processing. For the ID authentication processing, a device controlling cancellation of the warning state of the intruder detecting apparatus communicates with the device carried by the user and a feeble radio wave or low-power radio system is used.

However, when the ID authentication processing is performed all the time, radio communication is always performed, leading to an increase in power consumption. In particular, in the case of the vehicle-mounted intruder detecting apparatus that is often actuated by a power supply such as a battery or a cell that cannot continuously supply power, time during which the power supply can be used is extremely reduced.

Conversely, when ID authentication is periodically performed and a time interval from time when the ID authentication processing ends once until the next ID authentication processing is started is extended in order to set a durable time of the battery as long as possible, time during which the ID authentication processing is not performed is increased. This makes it more likely that people other than the user illegally approach the vehicle. Consequently, convenience of the intruder detecting apparatus is deteriorated.

Thus, the conventional intruder detecting apparatus adopts a system for starting the ID authentication processing with an operation performed by the user as a trigger. For example, the intruder detecting apparatus adopts a system for starting the ID authentication processing with detection of a change in an electrostatic capacity at the time when the user touches a door knob by a touch sensor or detection of vibration of the portable device at the time when the user moves by a vibration sensor provided in the portable device carried by the user as a trigger.

Besides, a Patent Document 1 (JP-A-8-329358, laid open on Dec. 13, 1996) describes a vehicle-mounted crime prevention apparatus that receives a reflected wave of a radio wave emitted from a radio wave emitter and detects approach of a person with a radio wave type Doppler sensor.

A Patent Document 2 (JP-A-2001-34855, laid open on Feb. 9, 2001) describes an intruder detecting apparatus including a pyroelectric sensor that detects a heat ray emitted from a human, a Doppler sensor that analyzes, in response to a result of the detection by the pyroelectric sensor, periods of a microwave transmitted from the Doppler sensor itself and a detection wave from the human to judge whether the human is an intruder, and an alarm device that executes threatening processing only when the human is regarded as an intruder on the basis of a result of the judgment by the Doppler sensor.

There is also a Patent Document 3 (JP-A-2003-182524, laid open on Jul. 3, 2003) as a document disclosing a technique for canceling a theft warning mode of a vehicle theft prevention apparatus when it is detected that a legal driver gets on a vehicle or the legal driver approaches the vehicle or when predetermined operation is performed by a user.

There is also a Patent Document 4 (JP-B-7-5062, published on Aug. 2, 1986) that discloses a vehicle theft prevention apparatus that has a function for distinguishing, paying attention to a difference of durations of Doppler signals, vibration applied to a vehicle and an operation of an intruder into the vehicle with a Doppler sensor and executing threatening processing only when an intruder into the vehicle is detected.

### DISCLOSURE OF THE INVENTION

However, in the system for detecting that a user touches a door knob and starting the ID authentication as in the conventional techniques, there are problems as described below. In the system, it is necessary to provide touch sensors in plural doors in order to make it possible to automatically perform cancellation of the warning state of the intruder detecting apparatus even when a door knob on a door other than a door provided in a driver's seat is operated. When the plural touch sensors are provided in this way, there is a problem in that an increase in size and an increase in cost of the intruder detecting apparatus are caused.

In the system for starting the ID authentication processing with detection of vibration of the portable device at the time when the user moves by the vibration sensor set in the portable device as a trigger, even when the user is not prevent near a vehicle, a request for starting the ID authentication may be transmitted from the portable device to the intruder detecting apparatus. However, if the user is present outside an area in which the portable device and the intruder detecting apparatus are capable of communicating with each other by radio, such a request for starting the ID authentication is not received by the intruder detecting apparatus. Thus, it is impossible to control wasteful power consumption involved in unnecessary radio communication.

In the technique described in the Patent Document 1, when the period of the detection wave is shorter than the period of the microwave transmitted by the Doppler sensor, it is judged that a person intending to intrude a vehicle is approaching a monitoring area. However, even when a person not intending to intrude into the vehicle is approaching the monitoring area, since the period of the microwave is shorter than the period of the detection wave, it is judged that the person intends to intrude into the vehicle. Therefore, in the technique described in the Patent Document 1, since the alarm device operates even when a person not intending to intrude into the vehicle approaches the monitoring area, it cannot be said that an appropriate alarm is given to only an intruder.

In the technique described in the Patent Document 2, an alarm is changed stepwise according to time during which a movable body is present outside a vehicle by adding a timer circuit to an alarm device. Therefore, it is likely that an alarm of a large volume is given by the alarm device even in a situation in which a legal user of a vehicle stays outside the vehicle for a long time, for example, a situation in which the user loads and unloads baggage or a situation in which the user is washing the vehicle. Accordingly, in the technique described in the Patent Document 2, as in the technique described in the Patent Document 1, it cannot be said that an appropriate alarm is given to only an intruder.

In the technique described in the Patent Document 3, it is judged whether a driver has approached the vehicle by performing communication between a vehicle theft prevention apparatus and a portable transmitter. Since electric power is wasted often in such communication, in the technique described in the Patent Document 3, wasteful electric power is consumed to detect that the driver approaches the vehicle.

In the technique described in the Patent Document 4, the same difference of durations occurs between a Doppler signal for detecting vibration applied to the vehicle and each of a Doppler signal at the time when it is detected by the Doppler sensor that a legal user enters the vehicle and a Doppler signal at the time when it is detected by the Doppler sensor that a person intending to commit a theft enters the vehicle. Therefore, even when the legal user enters the vehicle, an alarm device may operate. Accordingly, in the technique described in the Patent Document 4, it cannot be said that a proper alarm is given to only an intruder.

The invention has been devised in view of the conventional problem described above and it is an object of the invention to realize an intruder detecting apparatus that can sufficiently and wastelessly perform ID authentication necessary for performing setting or cancellation of a warning state of the intruder detecting apparatus or execution of threatening processing without causing an increase in size, an increase in cost, and an increase in power consumption of the apparatus and realize an intruder threatening apparatus including the intruder detecting apparatus.

In order to solve the problems, an intruder detecting apparatus of the invention is an intruder detecting apparatus that gives an execution instruction for threatening processing to external threatening executing means capable of executing threatening processing for threatening an illegal intruder into a monitoring area. The intruder detecting apparatus is characterized by including: a Doppler sensor that detects a moving object; communication means that is capable of communicating with the outside of the communication means; authentication processing means that performs communication between the communication means and a portable terminal carried by a user on the basis of moving object presence/absence information indicating whether the moving object is detected by the Doppler sensor, reads out portable terminal side ID information capable of specifying the user registered in advance in the portable terminal, and collates intruder detecting apparatus side ID information capable of specifying the user registered in advance in the intruder detecting apparatus and the portable terminal side ID information to thereby identify whether the object is the user; and control means that gives an execution instruction for the threatening processing to the threatening executing means on the basis of moving object identification information indicating whether the intruder detecting apparatus side ID information and the portable terminal side ID information coincide with each other.

According to the constitution, since identification processing is started in response to the detection of the Doppler sensor that can detect an approaching object at high sensitivity by using a microwave, it is possible to improve reliability of intruder detection.

In the authentication processing means, processing for identifying whether the moving object is the user is performed on the basis of the moving object presence/absence information indicating whether a moving object is detected by the Doppler sensor. Therefore, since it is possible to start identification processing for the user by the authentication processing means when an object approaching the vehicle is detected by the Doppler sensor, it is possible to control wasteful power consumption involved in unnecessary identification processing.

The control means gives an execution instruction for threatening execution processing to the threatening executing means on the basis of the moving object identification information indicating whether the intruder detecting apparatus side ID information and the portable terminal side ID information coincide with each other. Thus, only when it is judged by the identification processing that a person approaching the vehicle is not a legal user of the vehicle, it is possible to execute the threatening processing against the person. Therefore, it is possible to give an appropriate alarm only to an intruder into the vehicle.

The Doppler sensor can detect a moving object in a wide area by adjusting a transmission direction of a microwave. Thus, for example, it is possible to detect approach of the user to the vehicle from many directions simply by setting the Doppler sensor in one place of the vehicle. In other words, even when the user is not in a specific area around the vehicle, it is possible to start the identification processing with the authentication processing means without setting the Doppler sensor in plural places of the vehicle. Thus, it is possible to control an increase in size and an increase in cost of the intruder detecting apparatus.

Since the authentication processing means performs the identification processing by collating the intruder detecting apparatus side ID information and the portable terminal side ID information, it is possible to perform more highly accurate identification processing. Thus, it is possible to cause the external threatening processing executing means to more accurately execute appropriate threatening processing against only an intruder into the vehicle.

Because of the reasons described above, it is possible to realize an intruder detecting apparatus that can perform sure and wasteless intruder detection without causing an increase in size and an increase in cost of the intruder detecting apparatus or an increase in cost of use of the intruder detecting apparatus.

In order to solve the problems, the intruder detecting apparatus of the invention is an intruder detecting apparatus that gives an execution instruction for threatening processing to external threatening executing means capable of executing threatening processing for threatening an illegal intruder into a monitoring area. The intruder detecting apparatus is characterized by including: a Doppler sensor that performs detection of a moving object and detection of an operation peculiar to a user capable of specifying the user; authentication processing means that collates peculiar operation information indicating whether the Doppler sensor detects an operation peculiar to the user and intruder detecting apparatus side ID information capable of specifying the user registered in advance in the intruder detecting apparatus on the basis of moving object presence/absence information indicating whether a moving object is detected by the Doppler sensor to thereby identify whether the object is the user; and control means that gives an execution instruction for the threatening processing to the threatening executing means on the basis of the moving object identification information indicating whether the peculiar operation information and the intruder detecting apparatus side ID information coincide with each other.

According to the constitution, since identification processing by the authentication processing means is started in response to a result of the detection of the Doppler sensor that can detect an approaching object at high sensitivity by using a microwave, it is possible to improve reliability of intruder detection.

In the authentication processing means, identification processing is performed on the basis of the peculiar operation information for specifying an operation peculiar to the user. Therefore, when the peculiar operation is performed by the user, it is possible to start the identification processing for the user by the authentication processing means. Thus, it is possible to control wasteful power consumption involved in unnecessary processing.

The control means gives an execution instruction for threatening execution processing to the threatening executing means on the basis of the moving object identification information indicating whether the peculiar operation information and the intruder detecting apparatus side ID information coincide with each other. Thus, only when it is judged by the authentication processing means that an operation peculiar to a legal user is not performed, it is possible to execute the threatening processing against a person performing the operation. Therefore, it is possible to give an appropriate alarm only to an intruder into the vehicle.

The Doppler sensor can detect a moving object in a wide area by adjusting a transmission direction of a microwave. Thus, for example, simply by setting the Doppler sensor in one place of the vehicle, it is possible to detect operations of the user in a wide range. In other words, the Doppler sensor is not set in plural places of the vehicle and, even when the user is not in a specific area around the vehicle, it is possible to start the identification processing with the authentication processing means. Thus, it is possible to control an increase in size and an increase in cost of the intruder detecting apparatus.

Because of the reasons described above, it is possible to realize an intruder detecting apparatus that can perform sure and wasteless intruder detection without causing an increase in size and an increase in cost of the intruder detecting apparatus or an increase in cost of use of the intruder detecting apparatus.

Since the identification processing is performed by detecting an operation peculiar to the user using the Doppler sensor, it is possible to use the Doppler sensor as a part of the authentication processing means. Therefore, it is possible to simplify a constitution of the intruder detecting apparatus.

Even if the user does not carry a portable terminal in which ID information is recorded, the user can cause the authentication processing means to execute the identification processing by executing an operation peculiar to the user. In other words, even if the user does not have a portable terminal, the user can prevent an execution instruction for the threatening processing from being given to the threatening processing executing means from the control means. Thus, it is possible to improve convenience for the user.

In order to solve the problems, an intruder threatening apparatus of the invention is characterized by including: threatening executing means that executes threatening processing for threatening an illegal intruder into a monitoring area; and the intruder detecting apparatus with any one of the constitutions described above.

According to the constitution, the intruder threatening apparatus can execute the threatening processing using the intruder detecting apparatus that performs appropriate intruder detection. Thus, it is possible to surely apply the threatening processing to an intruder while preventing execution of unnecessary threatening processing. Therefore, it is possible to execute appropriate threatening processing against the intruder while controlling power consumption.

An intruder threatening apparatus for a vehicle of the invention is characterized in that the intruder threatening apparatus is mounted on a vehicle.

According to the constitution, since the intruder threatening apparatus is attached to the vehicle, it is possible to apply crime prevention measures to vehicles that are most frequently stolen.

In order to solve the problems, the intruder threatening apparatus for a vehicle of the invention is characterized by detecting, using the Doppler sensor, a relative movement caused between an object around a vehicle and the vehicle when a specific operation is applied to the vehicle by the user.

According to the constitution, the intruder threatening apparatus for a vehicle detects, using the Doppler sensor, a relative movement caused when a specific operation by the user is applied to the vehicle and starts the identification processing on the basis of a result of the detection. This makes it unnecessary to observe a level of communication intensity between the portable terminal and the intruder detecting apparatus in order to perform the identification processing. Thus, it is possible to reduce unnecessary communication and control power consumption.

### BRIEF DESCRIPTION OF THE DRAWINGS

FIG. 1 is a block diagram showing a constitution of an intruder detecting apparatus according to an embodiment of the invention.

FIG. 2 is a diagram for explaining a procedure for automatically setting a warning state of an intruder detecting apparatus 1 in the intruder detecting apparatus in FIG. 1.

FIG. 3 is a flowchart showing another procedure of processing in the intruder detecting apparatus in FIG. 1.

FIG. 4 is a diagram for explaining a procedure for automatically canceling the warning state of the intruder detecting apparatus in the intruder detecting apparatus in FIG. 1.

FIG. 5 is a flowchart showing a procedure of processing in the intruder detecting apparatus in FIG. 1.

FIG. 6 is a flowchart showing another procedure of the processing in the intruder detecting apparatus in FIG. 1.

### BEST MODE FOR CARRYING OUT THE INVENTION

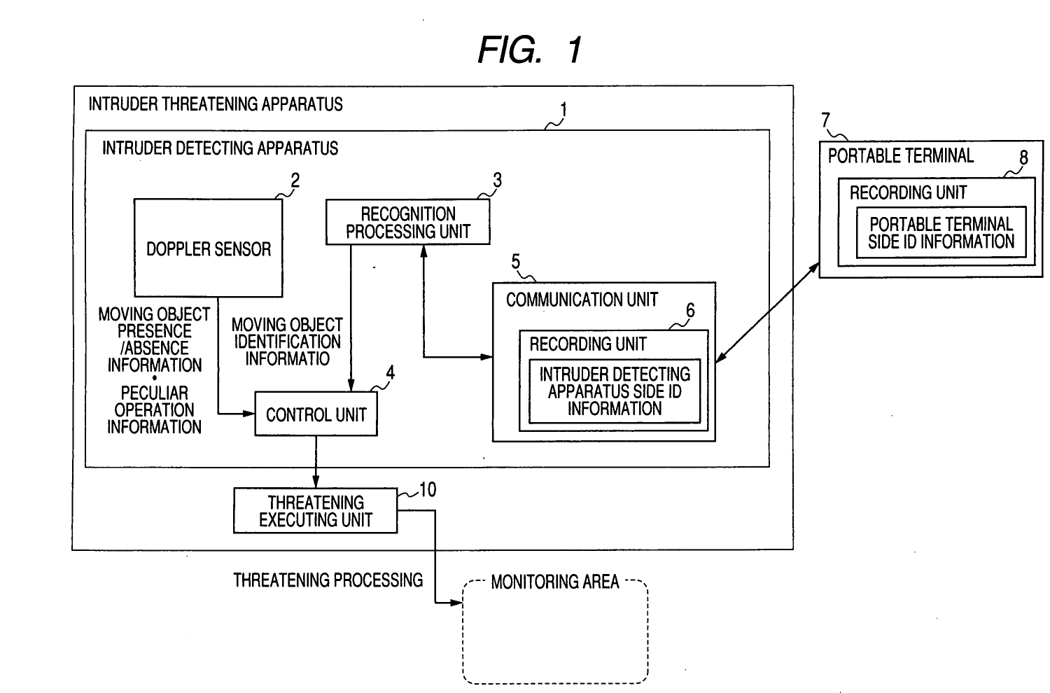

An embodiment of the invention will be explained as follows on the basis of FIGS. 1 to 6. In the description of this embodiment, an intruder detecting apparatus of the invention is applied to a vehicle-mounted crime prevention apparatus.

As shown in FIG. 1, an intruder detecting apparatus 1 in this embodiment includes a Doppler sensor 2 that can detect a moving object by transmitting a microwave and measuring a change in frequency, energy, or the like of a reflected wave from an object, a communication unit 5 that is capable of performing radio communication with a portable terminal 7 such as a remote controller carried by a user and reading out portable terminal side ID information, a recording unit 6 in which intruder detecting apparatus side ID information is registered, an authentication processing unit (authentication processing means) 3 that identifies whether the moving object is the user by collating the portable terminal side ID information and the intruder detecting apparatus side ID information, and a control unit (a control device) 4 that performs setting and cancellation for a standby state described later, setting and cancellation for a warning state described later, and an execution instruction for threatening processing of the intruder detecting apparatus 1. The recording unit 6 is provided in the communication unit 5.

Note that, in claims and this specification, the portable terminal side ID information means peculiar information capable of specifying the user registered on the portable terminal 7 side and the intruder detecting apparatus side ID information is peculiar information capable of specifying the user registered on the intruder detecting apparatus 1 side.

When the Doppler sensor 2 detects approach of an object, the Doppler sensor 2 transmits moving object presence/absence information to the control unit 4. When the control unit 4 receives the moving object presence/absence information, the control unit 4 analyzes the moving object presence/absence information and instructs, on the basis of a result of the analysis, the authentication processing unit 3 to perform processing for identifying whether the moving object is the user. The moving object presence/absence information means information indicating whether a moving object is detected by the Doppler sensor.

When the authentication processing unit 3 performs processing for identifying whether the moving object is the user, the authentication processing unit 3 sends moving object identification information to the control unit 4. When the control unit 4 receives the moving object presence/absence information, the control unit 4 issues an execution instruction for threatening processing to an external threatening executing unit 10 described later on the basis of the moving object identification information. The moving object identification information means information indicating whether an approaching object is identified as the user by the authentication processing unit 3.

The intruder detecting apparatus 1 uses a rechargeable battery, to which electric power is supplied from a cigar adapter while a vehicle is traveling, as a power supply. On the other hand, the portable terminal 7 uses a battery separately from the power supply for the intruder detecting apparatus 1. It is possible to continuously use the portable terminal 7 for several days without supply of electric power from the outside.

The threatening executing unit (threatening executing means) 10 connected to the intruder detecting apparatus 1 is provided outside the intruder detecting apparatus 1. The threatening executing unit 10 applies the threatening processing to an intruder in response to an instruction for executing the threatening processing issued by the control unit 4. As the “threatening processing”, it is possible to use sounding of a buzzer or a light-emitting operation of an LED as described later.

A unit obtained by integrally constituting the intruder detecting apparatus 1 and the threatening executing unit 10 is described as the “intruder threatening apparatus” in this specification and claims.

It is possible to use an LED or a buzzer as the threatening executing unit 10. The LED or the buzzer is used not only for the threatening processing against an approaching object other than the user but also for operation confirmation. The LED is set to perform flickering with low light-emitting intensity or a long period at the time of the operation confirmation and perform flickering with high light-emitting intensity or a short period at the time of the threatening processing. When the threatening processing is applied to an approaching object other than the user using the LED or the buzzer, it is possible to obtain an effect of informing people around the vehicle of occurrence of abnormality.

In this specification and claims, the warning state of the intruder detecting apparatus 1 means a state in which it is possible to detect a moving object around the intruder detecting apparatus 1 with the Doppler sensor 2, it is possible to communicate with the portable terminal 7 with the communication unit 5, it is possible to perform the authentication processing by the authentication processing means, and it is possible to execute the threatening processing with the threatening executing unit 10 in response to an instruction of the control unit 4. On the other hand, the standby state of the intruder detecting apparatus 1 is a state from a point when a state of non-operation of the intruder detecting apparatus 1 is ended by the control unit 4 until a point when the warning state of the intruder detecting apparatus 1 is started by the control unit 4 or a state until the state of non-operation of the intruder detecting apparatus 1 is started again. In this standby state, the threatening processing by the threatening executing unit 10 is not executed.

The portable terminal 7 includes a recording unit 8 in which the portable terminal side ID information is registered. The portable terminal 7 is not only used for ID authentication but also used by the user to manually set or cancel the warning state of the intruder detecting apparatus 1. The manual setting or canceling of the warning state of the intruder detecting apparatus 1 by the user is performed by using a method with which, when the user presses a button for setting or cancellation of the warning state of the intruder detecting apparatus 1 provided in the portable terminal 7, information to that effect is transmitted to the intruder detecting apparatus 1 by radio communication between the communication unit 5 and the portable terminal 7 and, in response to the information, setting or cancellation of the warning state of the intruder detecting apparatus 1 is performed by the control unit 4.

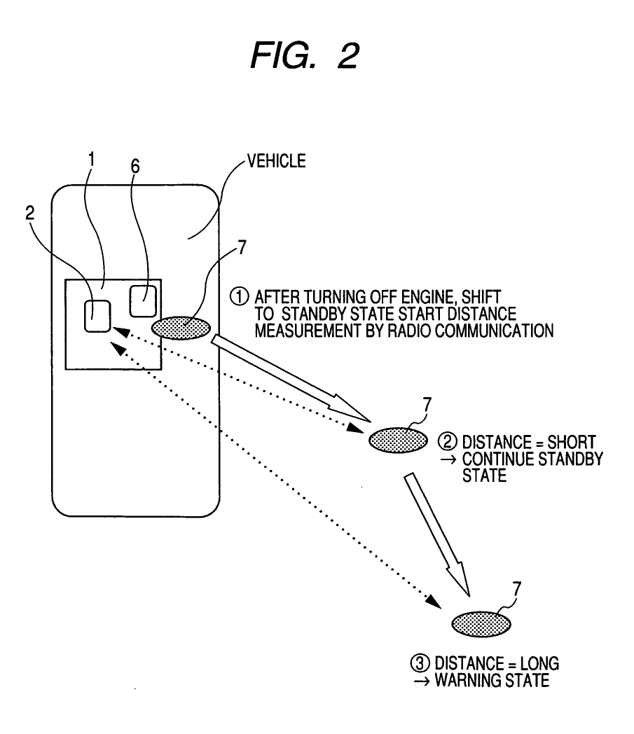

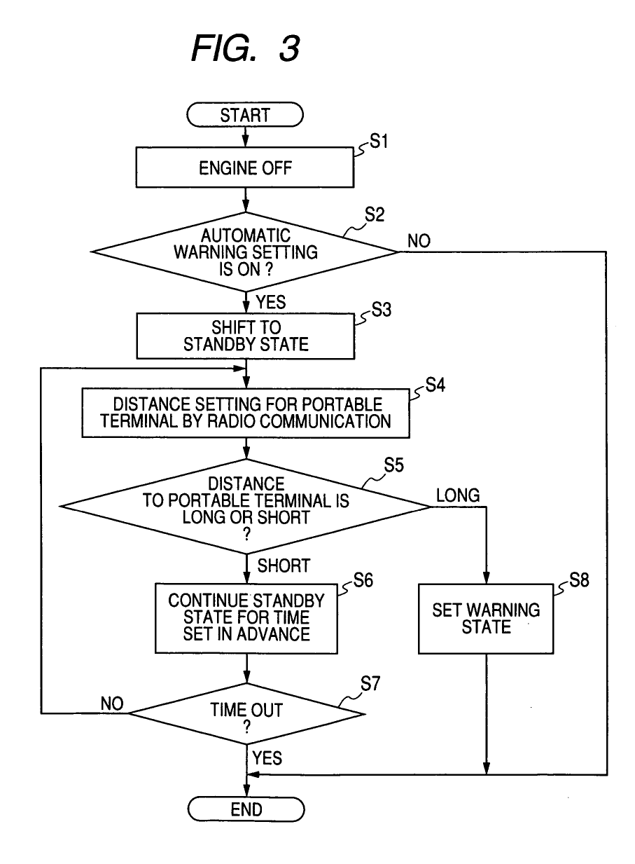

First, a procedure for setting the warning state of the intruder detecting apparatus 1 when the user does not use the vehicle will be explained using FIGS. 2 and 3. FIG. 2 is a diagram for explaining a procedure for automatic warning setting. FIG. 3 is a flowchart showing the procedure for the automatic warning setting. The automatic warning setting means that the user does not perform intentional operation and setting for the warning state of the intruder detecting apparatus 1 is automatically performed.

When the user is driving the vehicle attached with the intruder detecting apparatus 1, the intruder detecting apparatus 1 is in a non-operating state. On the other hand, when the user leaves the vehicle, the intruder detecting apparatus 1 is in a state in which the automatic warning setting is possible.

As shown in FIG. 2, when the user turns off an engine of the vehicle, the intruder detecting apparatus 1 automatically shifts to the standby state with stop of power supply to the intruder detecting apparatus 1 as a trigger.

In the standby state, the communication unit 5 (see FIG. 1) performs radio communication with the portable terminal 7 held by the user. The control unit 4 (see FIG. 1) starts distance measurement processing for measuring a distance between the portable terminal 7 and a vehicle body on the basis of communication sensitivity between the communication unit 5 (see FIG. 1) and the portable terminal 7.

It is assumed that, as shown in FIG. 2, the user moves away from the vehicle while holding the portable terminal 7. In this process, when it is judged by the distance measurement processing that the user is near from the vehicle body, the standby state is continued. When it is judged by the distance measurement that the user has moved away from the vehicle, that is, the user is distant from the vehicle, setting for the warning state of the intruder detecting apparatus 1 is automatically performed by the control unit 4.

The procedure for performing the automatic warning setting will be explained more in detail using FIG. 3. When the user turns off the engine of the vehicle (S1), power supply from the vehicle to the intruder detecting apparatus 1 is stopped and the intruder detecting apparatus 1 operates using the own rechargeable battery as a power supply. If the automatic warning setting is ON (S2), the intruder detecting apparatus 1 automatically shifts to the standby state with the stop of the power supply from the vehicle as a trigger (S3).

In the standby state, the communication unit 5 performs radio communication with the portable terminal 7 held by the user and the control unit 4 measures a distance between the portable terminal 7 and the vehicle body on the basis of communication sensitivity between the communication unit 5 and the portable terminal 7 (S4 and S5).

The distance measurement in S4 is performed at a time interval set in advance, for example, an interval of 10 seconds. When it is judged by the distance measurement that the user is within a distance from the vehicle body set in advance, for example, 5 m from the vehicle, the standby time is continued for time set in advance, for example, 10 minutes by the control unit 4 (S6). In other words, it is judged by the control unit 4 that a present situation is a situation in which the user is getting on or off the vehicle after the engine is turned off or the user is loading or unloading baggage.

When it is judged by the distance measurement that the user is outside the distance from the vehicle body set in advance, that is, when it is judged by the distance measurement that the user has left the vehicle, setting for the warning state of the intruder detecting apparatus 1 is automatically performed by the control unit 4 (S8). Therefore, the user does not need to perform intentional operation for setting the warning state, for example, operation such as pressing of a warning state setting switch in the portable terminal 7. When the warning state is automatically set, the communication unit 5 notifies the portable terminal 7 to that effect. On the basis of this notification, a sound message indicating that the warning state is set is sent from the portable terminal 7 or display indicating that the warning state is set is made on an image display unit in the portable terminal 7. Consequently, the user can confirm that the warning state is automatically set.

After the standby state is continued in S6, it is judged by the control unit 4 whether the standby state has continued for time set in advance after the engine is turned off and time-out of the standby state has occurred (S7). When it is judged in S7 that the time-out of the standby state has not occurred, the procedure returns to S4 and the distance measurement processing is continued. On the other hand, when the user does not move away from the vehicle when the set time has elapsed after the engine of the vehicle is turned off, the standby state is canceled by the control unit 4 and the intruder detecting apparatus 1 shifts to an on-operating state. The communication unit 5 notifies the portable terminal 7 that the intruder detecting apparatus 1 has shifted to the non-operating state. The user can confirm that the intruder detecting apparatus 1 has shifted to the non-operating state.

The “non-operating state of the intruder detecting apparatus 1” does not mean a state in which all blocks in the intruder detecting apparatus 1 do not function. The control unit 4 and the communication unit 5 in the intruder detecting apparatus 1 need to operate in order to perform the processing for notification to the portable terminal 7.

Since an operation state of the intruder detecting apparatus 1 is notified to the portable terminal 7 by the communication unit 5 in this way, the user can manually set the warning state of the intruder detecting apparatus 1 using the portable terminal 7, for example, when the user does not use the vehicle but continues to stay near the vehicle. It goes without saying that, when it is judged by performing the distance measurement using the control unit 4 that the user has left the vehicle, setting for the warning state may be automatically performed by the control unit 4.

A procedure for automatically performing cancellation of the warning state of the intruder detecting apparatus 1 without intentional operation by the user when the user approaches the vehicle will be explained. When the vehicle is not used, the Doppler sensor 2 is operating in order to detect approach of a person getting close to the periphery of the vehicle. A state in which the Doppler sensor 2 is operating in order to detect approach of a person approaching the periphery of the vehicle but has not detected a person approaching the periphery of the vehicle yet is assumed to be an initial state of the warning state.

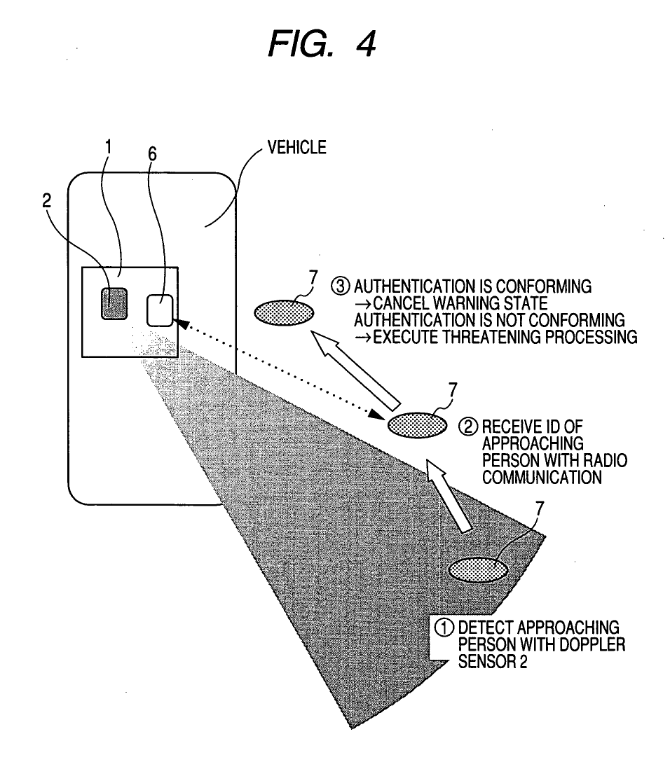

As shown in FIG. 4, a situation in which the portable terminal 7 gradually approaches the vehicle as the user approaches the vehicle in the initial state of the warning state is supposed. In this case, when the Doppler sensor 2 detects approach of an object, as shown in FIG. 1, the Doppler sensor 2 sends moving object presence/absence information to the control unit 4. When the control unit 4 receives the moving object presence/absence information, the control unit 4 instructs the authentication processing unit 3 to perform processing for identifying whether the object is the user. The authentication processing unit 3 starts ID authentication in response to the instruction.

Thereafter, as shown in FIG. 4, the intruder detecting apparatus 1 receives portable terminal side ID information according to radio communication between the portable terminal 7 and the communication unit 5 (see FIG. 1). The authentication processing unit 3 (see FIG. 1) reads out the intruder detecting apparatus side ID information registered in the recording unit 6 (see FIG. 1) in the intruder detecting apparatus 1 and collates the portable terminal side ID information and the intruder detecting apparatus side ID information to thereby perform the ID authentication.

As shown in FIG. 1, when it is judged by the authentication processing unit 3 that the two pieces of ID information coincide with each other and the ID authentication is conforming, moving object identification information indicating that the ID authentication is conforming is sent to the control unit 4. On the basis of this moving object identification information, the control unit 4 cancels the warning state of the intruder detecting apparatus 1. When it is judged that the two pieces of ID information do not coincide with each other and the ID authentication is not conforming, moving object identification information indicating that the ID authentication is not conforming is sent to the control unit 4. On the basis of this moving object identification information, the control unit 4 instructs the threatening executing unit 10 to execute the threatening processing. The threatening executing unit 10 executes the threatening processing in response to the instruction.

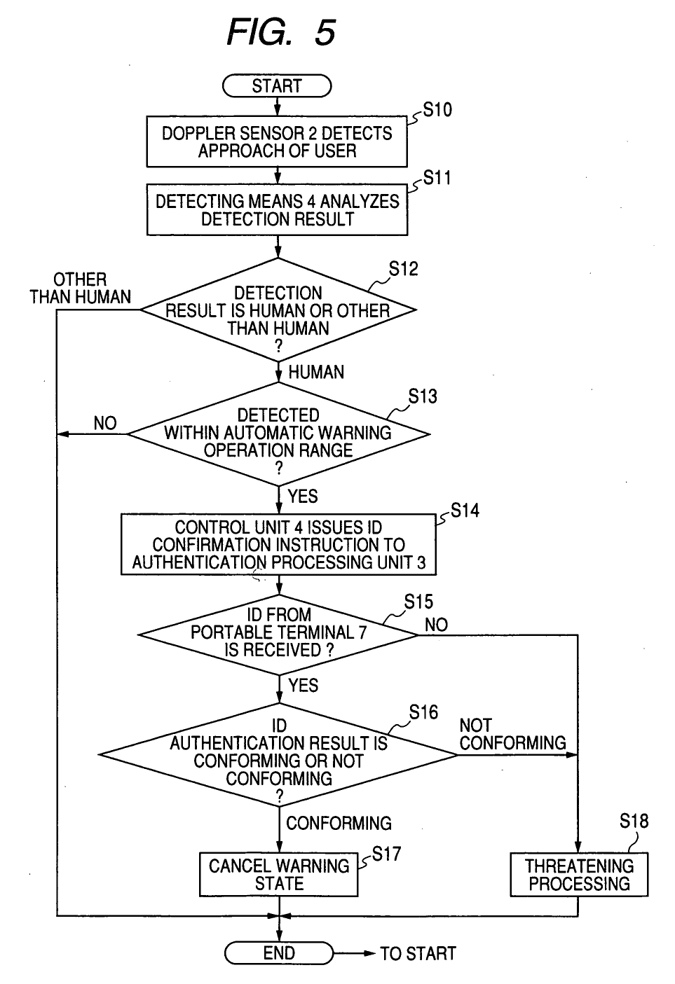

A procedure for canceling the automatic warning state will be explained more in detail using FIG. 5. When the Doppler sensor 2 detects approach of the user in the initial state of the warning state (S10), the Doppler sensor 2 sends moving object presence/absence information to the control unit 4. When the control unit 4 receives the moving object presence/absence information, the control unit 4 performs analysis of a result of the detection by the Doppler sensor 2 (S11).

In the analysis of the detection result, first, it is judged whether an approaching object is a human (S12). The judgment on whether an approaching object is a human is performed according a method of analyzing a lower end position, a size, moving speed, or the like of the approaching object. If it is judged that these values are in ranges corresponding to a human, the approaching object is regarded as a human.

When it is judged by the control unit 4 that the approaching object is a human, subsequently, it is judged by the control unit 4 whether a human is detected in an automatic warning operation range (S13). In this specification and claims, the automatic warning operation range is a distance from the vehicle body set in advance, for example, 3 m from the vehicle. When an intruder is in the range, the intruder is an object to which the threatening processing is applied by the threatening executing unit 10. The judgment in S13 is realized by the control unit 4 performing the distance measurement processing.

When the control unit 4 judges that a human is detected in the automatic warning range, the intruder detecting apparatus 1 shifts to a state in which ID authentication processing described below is performed (S14 to S17). When it is judged that the approaching object is not a human and when it is judged that a human is detected outside the automatic warning operation range, the intruder detecting apparatus 1 returns to the initial state of the warning state.

The ID authentication processing is performed when the communication unit 5 communicates with the portable terminal 7 carried by the user by radio and the authentication processing unit 3 analyzes a result of the communication.

First, the control unit 4 issues an ID confirmation instruction to the authentication processing unit 3 (S14). In response to the ID confirmation instruction, the authentication processing unit 3 sends a signal instructing the portable terminal 7 to transmit ID information through the radio communication from the communication unit 5 to the portable terminal 7. When a type of the portable terminal 7 conforms to the intruder detecting apparatus 1, the portable terminal 7 transmits portable terminal side ID information to the communication unit 5 in response to this signal. First, it is judged by the authentication processing unit 3 whether the portable terminal side ID information is received (S15).

When it is judged by the authentication processing unit 3 that the portable terminal 7 conforms with the intruder detecting apparatus 1, that is, when the communication unit 5 receives the portable terminal side ID information in S15, the authentication processing unit 3 reads out the intruder detecting apparatus side ID information and collates the intruder detecting apparatus side ID information and the portable terminal side ID information (S16).

When it is judged by the authentication processing unit 3 that the portable terminal side ID information and the intruder detecting apparatus side ID information coincide with each other, that is, the ID authentication is conforming, moving object identification information indicating that the ID authentication is conforming is sent from the authentication processing unit 3 to the control unit 4. According to this moving object identification information, the control unit 4 instructs the threatening executing unit 10 to execute the threatening processing. The threatening executing unit 10 cancels the warning state in response to the instruction (S17).

However, when the portable terminal side ID information is not received from the portable terminal 7 (No in S15) and when it is judged by the authentication processing unit 3 that the portable terminal side ID information and the intruder detecting apparatus side ID information do not coincide with each other, that is, the ID authentication is not conforming (in the case of “not conforming” in S16), moving object identification information indicating that the ID authentication is not conforming is sent from the authentication processing unit 3 to the control unit 4. According to this moving object identification information, the control unit 4 instructs the threatening executing unit 10 to execute the threatening processing. The threatening executing unit 10 executes the threatening processing in response to the threatening executing unit 10 (S18).

However, even when an approaching person is not the user and a result of non-conformity is obtained as a result of the ID authentication, the approaching person is not always an intruder who is intentionally approaching the vehicle. Thus, it is preferable to apply the threatening processing to the approaching person stepwise.

It is preferable that first threatening processing is set as a light reaction such as sounding of a buzzer or lighting of an LED for a short time for calling attention of the approaching person and, when time from a point when the ID authentication processing is performed until a point when the approaching person moves away from the vehicle exceeds time set in advance, for example, ten minutes, a large reaction such as sounding of the buzzer for a long time and at large volume is performed as second threatening processing.

Energy and a frequency of a reflected wave of the microwave transmitted by the Doppler sensor 2 change according to an area (speed) of an object reflecting the microwave. For example, when an object approaching the vehicle is a small animal such as a cat or a bird, compared with the case in which the approaching object is a human, an area reflecting the microwave is small. Thus, energy of a reflected wave is small or time during which the reflected wave is detected is short. When an object approaching the vehicle is an object such as a bicycle, speed of which is higher than a human, an amount of change in energy of a reflected wave is large. In other words, it is possible to distinguish a size (speed) of an object approaching the vehicle by analyzing a result of detection by the Doppler sensor 2. Consequently, an approaching object may be judged as an object, against which the threatening processing is executed, only when it is judged that a size (speed) of the approaching object is within a range set in advance according to the analysis of a result of detection by the Doppler sensor 2.

It is preferable that, as a size of an approaching object judges as an object against which the threatening processing is executed by the control unit 4, height of the approaching object is 1 m or more to prevent the threatening processing from being executed against an approaching object other than a human such as a small animal or a vehicle. It is more preferable that height is 1 to 2 m and width is 50 cm or less. It is preferable that speed of the approaching object judged as an object against which the threatening processing is executed by the control unit 4 is 5 m/sec to prevent the threatening processing from being executed against a passing automobile or train. It is more preferable that the speed is 1.5 to 3 m/sec.

However, when an approaching object judged as larger than a human or judged as moving faster than a human is detected, it is likely that the approaching object does harm to the vehicle. Thus, it is preferable to perform only the threatening processing against the approaching object without performing the ID authentication for the approaching object.

It is also possible to adjust directivity of a microwave transmitted by the Doppler sensor 2 to set the intruder detecting apparatus to detect only approach of an object from a specific direction. In other words, it is also possible to set the intruder detecting apparatus to detect approach of an object only from, for example, a lateral direction of a door of a driver's seat rather than all directions of the vehicle.

According to the setting described above, it is possible to execute the threatening processing against only a human among objects approaching the vehicle. It is also possible to perform communication for ID authentication for an approaching object such that the Doppler sensor 2 detects an approaching object in an area only in a direction from which intruders often approach the vehicle. Thus, it is possible to control wasteful communication and reduce power consumption.

According to the method described above, the intruder detecting apparatus 1 starts ID authentication in response to detection of the Doppler sensor 2 that can detect an approaching object at high sensitivity by using a microwave. Setting or cancellation of the warning state of the intruder detecting apparatus 1 or the threatening processing is executed according to a result of the ID authentication. Thus, it is possible to accurately execute the threatening processing against only an intruder.

According to the method, the ID authentication processing is started by the authentication processing unit 3 only when a human approaches the vehicle. Thus, it is not likely that radio communication is performed when the user or a person other than the user is not present near the vehicle. Thus, it is possible to control wasteful power consumption involved in unnecessary radio communication.

The Doppler sensor 2 can detect an approaching object in a wide area by adjusting a transmission direction of a microwave. Thus, it is possible to detect approach of the user or a person other than the user to the vehicle from many directions simply by setting the Doppler sensor 2 in one place of the vehicle. In other words, even when the user or a person other than the user is not in a specific area around the vehicle, it is possible to start the ID authentication processing with the authentication processing unit 3 without setting the Doppler sensor 2 in plural places of the vehicle. Thus, it is possible to control an increase in size and an increase in cost of the intruder detecting apparatus 1.

When vibration is detected by a vibration sensor to start the ID authentication, it is necessary to build in the vibration sensor in a device such as a remote controller carried by the user. However, since the remote controller is carried and used by the user, an increase in size caused by altering the remote controller, for example, building in the sensor in the remote controller. On the other hand, in the case of the method described above, since the Doppler sensor 2 is built in the intruder detecting apparatus 1, the user sets the intruder detecting apparatus 1 in the vehicle and uses the intruder detecting apparatus 1. Thus, it is unnecessary to alter the portable terminal 7. It is possible to control an increase in size of the portable terminal 7 involved in alteration of the portable terminal 7 and control deterioration in an environment of use by the user.

Because of the reasons described above, in the method described above, there is an effect that it is possible to perform sure and wasteless intruder detection without causing an increase in size and an increase in cost of the intruder detecting apparatus 1 or an increase in cost of use of the intruder detecting apparatus 1.

It is possible to use the Doppler sensor 2 not only for starting the authentication processing but also for performing the authentication processing. When the Doppler sensor 2 is used for performing the authentication processing, cancellation of the warning state is a manual intruder detecting apparatus that is performed by intentional operation of the user. Since a procedure for setting the warning state when the user does not use the vehicle is the same as that described above, the above explanation applies to the procedure.

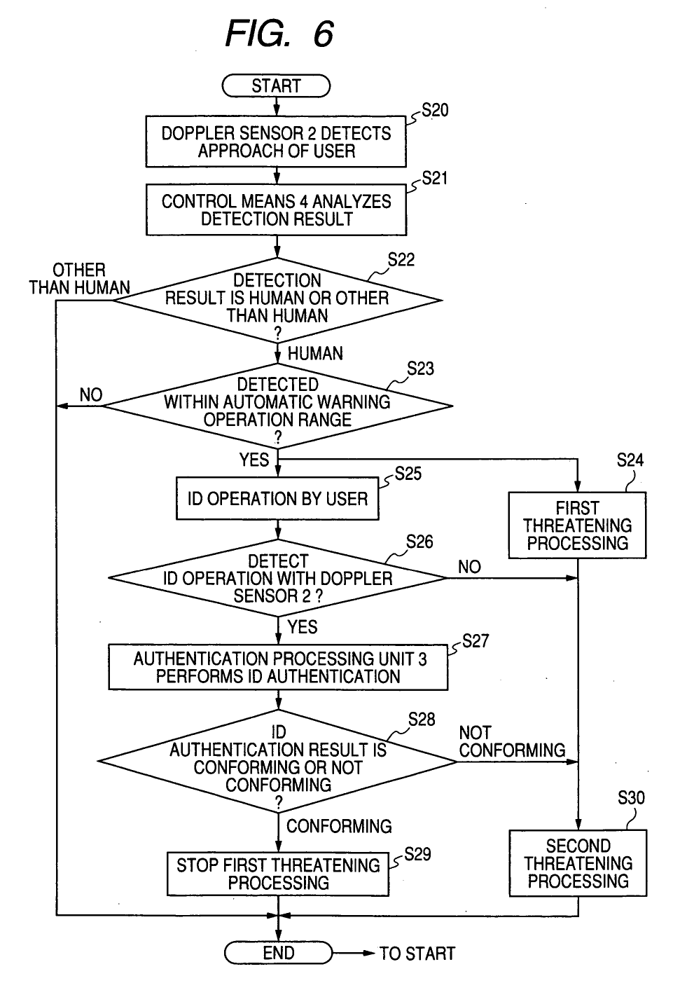

A procedure for canceling the warning state at the time when the Doppler sensor 2 is used to perform the authentication processing will be explained using FIG. 6. FIG. 6 is a flowchart showing a procedure of a manual method with which the user performs cancellation of the warning state of the intruder detecting apparatus 1 by intentionally performing operation.

When the vehicle is not used, the intruder detecting apparatus 1 is set in the warning state. In the initial state of the warning state, when the Doppler sensor 2 detects approach of the user (S20), the Doppler sensor 2 sends moving object presence/absence information to the control unit 4. When the control unit 4 receives the moving object presence/absence information, the control unit 4 analyzes a result of the detection by the Doppler sensor 2 (S21) and judges whether the approach of the object is approach of a human (S22). When it is judged that the approach of the object is approach of a human, the control unit 4 judges whether the object is detected within an automatic warning operation range set in advance (S23).

When it is judged that the object is detected within the automatic warning operation range, the control unit 4 instructs the threatening executing unit 10 to execute the first threatening processing. The threatening executing unit 10 performs the first threatening processing described later in response to the instruction (S24).

When the first threatening processing is performed, simultaneously, the intruder detecting apparatus 1 shifts to a state in which ID authentication processing described below is performed (S25 to S28). When it is judged by the control unit 4 that the approaching object is not a human and that the object is detected outside the automatic warning operation range, the intruder detecting apparatus 1 returns to the initial state of the warning state.

In S25, an ID operation (an operation peculiar to the user that is recognized by using the Doppler sensor 2) is performed by the user. Thereafter, it is judged by the Doppler sensor 2 whether the ID operation by the user is detected (S26). As the ID operation, it is possible to use, for example, an operation for continuing to wave the user's hand for three seconds or more near the center of the driver's seat door or an operation for knocking the vehicle body or a window or kicking a tire.

When the ID operation by the user is detected by the Doppler sensor 2 in the processing in S26, the authentication processing unit 3 reads out the intruder detecting apparatus side ID information. The authentication processing unit 3 collates peculiar operation information indicating whether the Doppler sensor 2 has detected the operation peculiar to the user and the intruder detecting apparatus side ID information to thereby perform ID authentication (S27) and judges whether the approaching object is the user (S28).

When the intruder detecting apparatus side information and the peculiar operation information coincide with each other and it is judged by the authentication processing unit 3 that the approaching person is the user, the authentication processing unit 3 sends moving object identification information indicating that the approaching person is the user to the control unit 4. When the control unit 4 receives the moving object identification information, the control unit 4 gives an instruction for stopping the first threatening processing to the threatening executing unit 10. The threatening executing unit 10 stops the first threatening processing in response to the instruction (S29). The intruder detecting apparatus 1 is shifted to the state of non-operation by the control unit 4.

However, when the ID operation is not detected by the Doppler sensor 2 within time set in advance, for example, ten minutes after the first threatening processing is started (when judgment of No is made in S26) or when the intruder detecting apparatus side ID information and the peculiar operation information do not coincide with each other (when judgment of non-conformity is made in S28), it is judged by the control unit 4 that the approaching person is not the user and the second threatening processing described later is executed (S30).

It is preferable that the threatening processing is performed stepwise, for example, as indicated by the flow described above, the second threatening processing is performed after the first threatening processing is performed. This is because the first threatening processing is executed in a state in which the ID authentication for confirming whether an approaching person is an intruder or the user is not performed yet. In addition, this is because, although the second threatening processing is executed when the ID authentication is applied to the approaching person and it is judged that the approaching person is not the user, even in this case, the approaching person is not always an intruder intentionally approaching the vehicle.

Thus, it is preferable that a light reaction such as sounding of a buzzer or lighting of an LED for a short time and at small volume for calling attention of the user to approach of an object is performed as the first threatening processing and, immediately after the ID authentication processing is performed, a reaction such as sounding of the buzzer at larger volume or for a longer time than the first threatening processing is performed as the second threatening processing, and, when time from a point when the ID authentication processing is performed until a point when the approaching person moves away from the vehicle exceeds time set in advance, for example, ten minutes, a large reaction such as sounding of the buzzer for a longer time and at larger volume is performed as third threatening processing.

As an ID operation in this case, it is possible to use an operation such as waving of the user's hand for three seconds or more near the center of the driver's seat door.

If the Doppler sensor 2 is adjusted to high sensitivity, it is possible to detect vibration of the vehicle itself. This is because, when the vehicle attached with the Doppler sensor 2 shakes, a relative positional relation between the Doppler sensor 2 and an object around the Doppler sensor 2 changes and the object around the Doppler sensor 2 is detected as if the object is moving. It is also possible to, making use of this phenomenon, for example, cause vibration in the vehicle by knocking the vehicle body or the window or kicking the tire and register information for specifying vibration according to an interval or the number or times of the knock in the recording unit 6 as the intruder detecting apparatus side ID information.

When the ID operation detected by the Doppler sensor 2 is used, as at the time when the portable terminal side ID information registered in the portable terminal 7 is used, it is necessary to realize high security. Thus, it is preferable to cause the Doppler sensor 2 to detect one ID operation obtained by combining plural operations. For example, it is possible to combine an operation of waving the user's hand near the driver's seat and an operation of waving the user's hand near the seat next to the driver' seat and use the operations as one ID operation.

It is preferable to perform ID authentication stepwise. For example, it is possible to use an ID operation at the time of ID authentication at a first stage and use the portable terminal side ID information registered in the portable terminal 7 at the time of ID authentication at a second stage.

Both the portable terminal side ID information registered in the portable terminal 7 and an ID operation detected by the Doppler sensor 2 may be used such that the ID operation detected by the Doppler sensor 2 is used as alternative means when the user does not have the portable terminal 7 at the time of ID authentication.

In this way, information indicating an operation of the user detected by the Doppler sensor 2 is used for the ID authentication processing as peculiar information for specifying the user. This makes it unnecessary to perform the radio communication between the portable terminal 7 and the communication unit 5 for the ID authentication processing described above. Moreover, it is possible to control power consumption.

Since the Doppler sensor 2 is adjusted to high sensitivity, it is possible to detect vibration of the vehicle itself. Therefore, it is possible to use the vibration of the vehicle as a trigger for ID authentication. For example, when vibration caused by knocking the window or kicking the tire is applied to the vehicle body, generation of the vibration in the vehicle is detected by the Doppler sensor 2. It is also possible that an execution instruction for ID authentication is issued from the control unit 4 to the authentication processing unit 3 in response to information indicating a result of the detection and the ID authentication is started by the authentication processing unit 3.

It is possible to obtain advantages described below by detecting vibration of the vehicle itself with the Doppler sensor 2 and using a result of the detection as a trigger for ID authentication in this way.

In the flows shown in FIGS. 5 and 6, in order to obtain one trigger for performing ID authentication, it is judged by the control unit 4 whether a human is detected within the automatic warning operation range. This judgment by the control unit 4 is realized by distance measurement processing for measuring a distance between the user and the vehicle body on the basis of communication sensitivity between the communication unit 5 and the portable terminal 7.

If a result of detection of vehicle vibration by the Doppler sensor 2 is used as a trigger for ID authentication as described above, it is possible to start the ID authentication without performing the distance measurement processing by the control unit 4.

Since an action such as kicking the tire or knocking the vehicle body or the window glass, which is used as a trigger for ID authentication, less easily occurs in a usual parking stage, it is possible to more surely and wastelessly perform the ID authentication. Therefore, it is possible to reduce communication time between the communication unit 5 and the portable terminal 7 and control power consumption.

When it is judged by the authentication processing unit 3 that a person causing the vibration is the user as a result of the ID authentication, cancellation of the warning state is performed. When it is judged that the person causing the vibration is not the user, the threatening processing is executed.

In this case, it is preferable that the ID authentication processing is performed by receiving the portable terminal side ID information registered in the portable terminal 7 with the communication unit 5 and, on the other hand, reading out the intruder detecting apparatus side ID information with the authentication processing unit 3 and collating the portable terminal side ID information and the intruder detecting apparatus side ID information. It is also preferable that the ID authentication processing is performed by detecting an ID operation performed by the user with the Doppler sensor 2 and, on the other hand, reading out the intruder detecting apparatus side ID information with the authentication processing unit 3 and collating peculiar operation information indicated by the ID operation performed by the user and the intruder detecting apparatus side ID information.

A microwave transmitted by the Doppler sensor 2 is transmitted through glass and plastic but is not transmitted through metal. Thus, when the intruder detecting apparatus 1 is set in the vehicle and used, an area (a dead angle) that the Doppler sensor 2 cannot detect because of metal portions forming the body of the vehicle is present. However, the Doppler sensor 2 can surely detect vibration applied to the vehicle.

Thus, it is possible to use both the detection of approach by the Doppler sensor 2 and the detection of vibration applied to the vehicle as a trigger for the ID authentication stepwise. For example, it is possible to surely detect approach of an object from a dead angle and perform the ID authentication by detecting vibration applied to the vehicle such as vibration due to opening of the door of the vehicle using a system for using the detection of approach by the Doppler sensor 2 as a first trigger for the ID authentication and using the detection of vibration applied to the vehicle by the Doppler sensor 2 as a second trigger for the ID authentication.

When the ID authentication is started in response to the detection of vibration applied to the vehicle, which is the second trigger, using this method, the threatening processing is executed after it is judged by the authentication processing unit 3 that the ID authentication is not conforming. In other words, the threatening processing is not performed while time required for the ID authentication passes after it is detected that vibration is applied to the vehicle. Thus, it is possible to prevent the threatening processing from being performed by mistake when an approaching person is the user.

According to the method described above, since the ID authentication processing is more surely performed, it is possible to establish a more sure crime prevention system.

According to the method, when vibration is applied to the vehicle, the vibration is detected by the Doppler sensor 2 and the ID authentication is performed in response to a result of the detection. Thus, it is possible to detect an intruder at high sensitivity, efficiently reduce radio communication for the ID authentication while improving reliability of intruder detection of the intruder detecting apparatus 1, and further control power consumption involved in the radio communication.

### INDUSTRIAL APPLICABILITY

According to the invention, in an intruder detecting apparatus that detects an intruder into a vehicle, a building, or the like, it is possible to sufficiently and wastelessly perform ID authentication processing for judging whether approach of an object is approach of a user or an intruder. It is possible to apply the intruder detecting apparatus to an intruder threatening apparatus that executes threatening processing against the intruder.

1. An intruder detecting apparatus that gives an execution instruction for threatening processing to external threatening executing means capable of executing threatening processing for threatening an illegal intruder into a monitoring area, the intruder detecting apparatus characterized by comprising:
a Doppler sensor that detects a moving object;
communication means that is capable of communicating with the outside of the communication means;
control means that judges whether an approaching object is a human on the basis of a result of the detection of the Doppler sensor; and
authentication processing means that performs, when the control means judges that a human is approaching, communication between the communication means and a portable terminal carried by a user reads out portable terminal side ID information capable of specifying the user registered in advance in the portable terminal, and collates intruder detecting apparatus side ID information capable of specifying the user registered in advance in the intruder detecting apparatus and the portable terminal side ID information to thereby identify whether the object is the user,
wherein the control means gives an execution instruction for the threatening processing to the threatening executing means on the basis of moving object identification information indicating whether the intruder detecting apparatus side ID information and the portable terminal side ID information coincide with each other.

2. An intruder threatening apparatus, characterized by comprising:
threatening executing means that executes threatening processing for threatening an illegal intruder into a monitoring area; and
an intruder detecting apparatus according to claim 1.

3. An intruder threatening apparatus for a vehicle, characterized in that an intruder threatening apparatus according to claim 2 is mounted on a vehicle.

4. An intruder threatening apparatus for a vehicle according to claim 3, characterized by detecting, using the Doppler sensor, a relative movement caused between an object around a vehicle and the vehicle when a specific operation is applied to the vehicle by the user.

5. An intruder detecting apparatus that gives an execution instruction for threatening processing to external threatening executing means capable of executing threatening processing for threatening an illegal intruder into a monitoring area, the intruder detecting apparatus characterized by comprising:
a Doppler sensor that performs detection of a moving object and detection of an operation peculiar to a user capable of specifying the user;
control means that judges whether an approaching object is a human on the basis of a result of the detection of the Doppler sensor; and
authentication processing means that collates, when the control means judges that a human is approaching, peculiar operation information indicating whether the Doppler sensor detects an operation peculiar to the user and intruder detecting apparatus side ID information capable of specifying the user registered in advance in the intruder detecting apparatus on the basis of moving object presence/absence information indicating whether a moving object is detected by the Doppler sensor to thereby identify whether the object is the user,
wherein the control means gives an execution instruction for the threatening processing to the threatening executing means on the basis of the moving object identification information indicating whether the peculiar operation information and the intruder detecting apparatus side ID information coincide with each other.

6. An intruder threatening apparatus, characterized by comprising:
threatening executing means that executes threatening processing for threatening an illegal intruder into a monitoring area; and
an intruder detecting apparatus according to claim 5.

7. An intruder threatening apparatus for a vehicle, characterized in that an intruder threatening apparatus according to claim 6 is mounted on a vehicle.

8. An intruder threatening apparatus for a vehicle according to claim 7, characterized by detecting, using the Doppler sensor, a relative movement caused between an object around a vehicle and the vehicle when a specific operation is applied to the vehicle by the user.
